(19) United States
(12) Patent Application Publication
(10) Pub. No.: US 2024/0291121 A1
(43) Pub. Date: Aug. 29, 2024

(54) BATTERY PROTECTION AT ALTITUDE

(71) Applicant: BAE Systems Controls Inc., Endicott, NY (US)

(72) Inventors: Michael Mallery, Apalachin, NY (US); Brian Cortes, Endicott, NY (US); Matthew S. Boecke, Endicott, NY (US); Robert J. Arbogast, Binghamton, NY (US); Laura Dionisio, Endicott, NY (US); Peter J. Arnold, Endicott, NY (US)

(73) Assignee: BAE Systems Controls Inc., Endicott, NY (US)

(21) Appl. No.: 18/115,233

(22) Filed: Feb. 28, 2023

(51) Int. Cl. H01M 50/578; B60L 3/04; B60L 50/60; B64D 27/24; H01M 50/51

(52) U.S. Cl. CPC H01M 50/578; B60L 3/04; B60L 50/60; B64D 27/24; H01M 50/51; B60L 2200/10; B64D 2221/00; H01M 2220/20

(57) ABSTRACT

A battery assembly includes a first plurality of battery cells, a second plurality of battery cells, and a switch between the first plurality of battery cells and the second plurality of battery cells. In an example, the first plurality of battery cells, the switch, and the second plurality of battery cells are connected in series to a load. In an example, the first plurality of battery cells, the second plurality of battery cells, and the switch are within an enclosure, which is within a pressure regulated section of an aircraft. The load may be external to the enclosure. The battery assembly further includes a controller configured to open the switch and the disconnect the first plurality of battery cells from the second plurality of battery cells, in response to an air pressure proximal to the first and second pluralities of battery cells falling below a threshold level.

### TECHNICAL FIELD

The present disclosure relates generally to battery technology, and more particularly to protection of battery packs.

### BACKGROUND

A battery is a popular source of electric power, e.g., providing direct current (DC) to a load. A battery has a positive terminal or cathode, and a negative terminal or anode. Multiple batteries can be coupled in series and/or parallel, to form a high voltage and/or high power DC power source.

Rechargeable batteries can be charged and discharged, and such charge and discharge cycles can occur multiple times over a life of a battery. For example, once the battery is discharged while in use, the battery can be recharged using an applied electric current, during which an original composition of the battery electrodes may be fully or at least partially restored by reverse current. Examples of such rechargeable batteries include lead-acid batteries and lithium-ion batteries.

Batteries can be used for any number of applications, such as used in consumer electronic devices, wearable devices, computers, electrical and non-electric vehicles, and/or many other devices or systems that use DC power. There remain several non-trivial issues with respect to operating battery packs.

### BRIEF DESCRIPTION OF THE DRAWINGS

FIG. 1 illustrates a battery assembly comprising a plurality of battery cells within an enclosure, wherein the plurality of battery cells are arranged in series, wherein the plurality of battery cells includes first one or more battery cells and second one or more battery cells, and wherein the battery assembly comprises a switch between the first one or more battery cells and the second one or more battery cells, and wherein the switch is turned off in response to an air pressure within the enclosure falling below a threshold pressure value, in accordance with an embodiment of the present disclosure.

FIG. 2 illustrates the battery assembly of FIG. 1 installed in an aircraft, in accordance with an embodiment of the present disclosure.

FIG. 3 illustrates a de-pressurization event in an aircraft, e.g., when the aircraft is at a first altitude H1, in accordance with an embodiment of the present disclosure.

FIG. 4 illustrates a de-pressurization event in an aircraft, e.g., when the aircraft is at a second altitude H2 that is higher than the first altitude H1 of FIG. 3, in accordance with an embodiment of the present disclosure.

FIGS. 5A and 5B illustrate fault scenarios occurring when the switch between the first one or more battery cells and the second one or more battery cells of FIG. 1 is closed, when the battery cells are disconnected from a load that is external to the enclosure, and when the air pressure within the enclosure is below a threshold air pressure, in accordance with an embodiment of the present disclosure.

FIGS. 6A and 6B illustrate fault scenarios occurring when the switch between the first one or more battery cells and the second one or more battery cells of FIG. 1 is opened, when the battery cells are disconnected from the load that is external to the enclosure, and when the air pressure within the enclosure is below the threshold air pressure, in accordance with an embodiment of the present disclosure.

FIG. 7 illustrates a battery assembly that is at least in part similar to the battery assembly of FIG. 1, and wherein the switch between the first one or more battery cells and the second one or more battery cells is controlled by a controller that is within the enclosure and/or by a system that is external to the enclosure, where the controlling of the switch is based at least in part on a sensor that is within the enclosure and/or a sensor that is external to the enclosure, in accordance with an embodiment of the present disclosure.

FIG. 8 illustrates a battery assembly comprising a plurality of battery cells within an enclosure, wherein the plurality of battery cells are arranged in series, wherein the plurality of battery cells includes (i) first one or more battery cells, (ii) second one or more battery cells, (iii) third one or more battery cells, and (iv) fourth one or more battery cells, wherein the battery assembly further comprises (A) a first switch between the first one or more battery cells and the second one or more battery cells, (B) a second switch between the second one or more battery cells and the third one or more battery cells, and (C) a third switch between the third one or more battery cells and the fourth one or more battery cells, and wherein the first switch, the second switch, and the third switch are turned off in response to an air pressure within the enclosure falling below a threshold pressure, in accordance with an embodiment of the present disclosure.

FIG. 9 illustrate a flowchart depicting a method for operating any of the battery assemblies described herein, in accordance with an embodiment of the present disclosure.

The figures depict various embodiments of the present disclosure for purposes of illustration only and are not necessarily drawn to scale. Numerous variations, configurations, and other embodiments will be apparent from the following detailed description.

### DETAILED DESCRIPTION

Disclosed are methodologies and structures for forming battery assemblies. The battery assemblies can be used in any number of applications, but are particularly useful when installed in aircrafts, or other applications susceptible to arcing or shorting between terminals of battery cells of such a battery assembly and an enclosure holding the battery cells due to a depressurization event (e.g., such as when an aircraft including the battery assembly is flying higher than a threshold altitude). In some embodiments, the battery assembly comprises an enclosure, first one or more battery cells and second one or more battery cells within the enclosure, and an intermediate switch between the first one or more battery cells and the second one or more battery cells. A first end switch is between the first one or more battery cells and a load that is external to the enclosure, and a second end switch is between the second one or more battery cells and the load. In an example, the first end switch, the first one or more battery cells, the intermediate switch, the second one or more battery cells, and the second end switch are connected in series to the load. In an example, the enclosure is within a section of an aircraft or other platform in which the air pressure is regulated.

The battery assembly comprises one or more sensors that may be within the enclosure and/or outside the enclosure. For example, a sensor detects air pressure within the enclosure (or may detect air pressure outside the enclosure, but within the pressure regulated section of the aircraft or platform), and outputs a sense signal. In an example, the sense signal is indicative of the air pressure proximal to the battery cells (e.g., air pressure inside or outside the enclosure). In general, and continuing with the example host platform of an aircraft, atmospheric pressure reduces with a gain in altitude, relative to standard atmospheric pressure at sea-level. In an example, in addition to, or instead of, providing an indication of air pressure, the sense signal may provide indication of an altitude of the battery assembly as well. Thus, the sensor (e.g., along with an attached sensor circuitry) may translate or correlate a detected air pressure to a corresponding altitude, and may provide an indication of the altitude of the battery assembly. During a depressurization event, if the air pressure within or adjacent the enclosure falls below a threshold pressure, this is indicated by the sense signal of the sensor. In one embodiment, a controller receives the sense signal. In response to the sense signal indicating the air pressure falling below a threshold air pressure and/or the altitude being higher than a threshold altitude, the controller opens one or more of the first end switch, the second end switch, and the intermediate switch. As will be described below, opening one or more the switches eliminate or reduce chances of arcing or shorting between the battery terminals and the enclosure, e.g., during a depressurization event. Numerous variations and embodiments will be apparent in light of the present disclosure.

### General Overview

There remain several non-trivial issues with respect to operating battery packs, such as battery packs used in aircrafts or other platforms susceptible to pressure changes. In an example, a battery pack including a plurality of battery cells is coupled in series with a load, where the plurality of battery cells is within an enclosure that is installed within an aircraft. A minimum clearance of “w1” is maintained between terminals of the battery cells and the conductive walls of the enclosure (or between the battery cell terminals and a conductive element coupled to the enclosure). In an example, the clearance w1 may be sufficient to prevent or reduce chances of electrical arcing and shorting of the terminals of the battery cells and the enclosure, e.g., when the air pressure within the enclosure is maintained at sea level air pressure or at an air pressure found at a relatively low altitude. In an example, the enclosure is within a section of the aircraft that has regulated air pressure (e.g., a pressurization system maintains a minimum air pressure within the section of the aircraft). In an example, when the aircraft climbs at a high altitude, there is a drop in atmospheric pressure outside the aircraft, based on the aircraft altitude. The pressurization system, however, regulates the air pressure to at least the minimum air pressure level within the aircraft. In an example, a depressurization event may cause the pressurization system to fail, e.g., due to a fault in the pressurization system and/or due to a crack or break in the body of the aircraft. If such depressurization event occurs at sufficient high altitude, the air pressure within the aircraft drops drastically (e.g., depending on the altitude and/or the severity of the depressurization event). Exacerbating this situation, air at lower pressure (e.g., at relatively higher altitude) is better conductor of electricity, compared to air at sea-level or at relatively lower altitude. Accordingly, if the depressurization event occurs at sufficient high altitude and the air pressure within the enclosure drops sufficiently (e.g., below a threshold pressure level), this increases the conductivity of the low-pressure air within the enclosure, and the clearance w1 between the battery terminals and the conductive walls of the enclosure may no longer be sufficient to prevent arcing or shorting between the battery terminals and the enclosure.

Accordingly, techniques are described herein to form a battery assembly to be installed in an aircraft or other platform susceptible to pressure changes, where chances of arcing or shorting between the battery terminals of the battery assembly and the enclosure is eliminated or at least reduced, e.g., during a depressurization event when the aircraft is flying at a high altitude (e.g., higher than a threshold altitude). For example, as will be described below, an intermediate switch between first one or more battery cells and second one or more battery cells is opened, in response to air pressure within an enclosure of the battery assembly falling below a threshold pressure. Opening the intermediate switch (also referred to herein as mid-battery pack switch or contactor), and/or one or more other switches of the battery assembly, eliminates, or at least reduces, chances of arcing or shorting between the battery terminals of the battery assembly and the enclosure.

In some embodiment, the battery assembly comprises the enclosure, and multiple battery cells within the enclosure. In some examples, the battery cells may be lithium ion battery cells, although other types of battery cells (such as lead acid battery cells or hydrogen cells) may also benefit from the techniques described herein.

In an example, the battery cells within the enclosure comprises first one or more battery cells and second one or more battery cells, and the intermediate switch between the first one or more battery cells and the second one or more battery cells. A first end switch is between the first one or more battery cells and a load that is external to the enclosure, and a second end switch is between the second one or more battery cells and the load. In an example, the first end switch, the first one or more battery cells, the intermediate switch, the second one or more battery cells, and the second end switch are connected in series to the load.

The battery assembly comprises one or more sensors that may be within the enclosure and/or outside the enclosure. For example, a sensor detects air pressure within the enclosure (or may detect air pressure outside the enclosure, but within the pressure regulated section of the platform), and outputs a sense signal. In an example, the sense signal is indicative of the air pressure proximal to the battery cells (e.g., air pressure inside or outside the enclosure) and/or an altitude of the battery assembly. For instance, the sensor (e.g., along with an attached sensor circuitry) may translate or correlate a detected air pressure to a corresponding altitude, and may provide an indication of the altitude of the battery assembly. Note that the detected air pressure and the detected altitude are generally correlated (lower air pressure translates to higher altitude, and higher air pressure translates to lower altitude).

As described above, air pressure is regulated inside a section of the platform that holds the battery assembly. Assume, for example, the platform is an aircraft, which may be manned or unmanned (e.g., unmanned aerial vehicle, or drone). In one such an example, the air pressure is maintained at somewhat constant level, e.g., is maintained within a target pressure range. In an example, the air pressure inside the aircraft is maintained substantially to an air pressure typically found at a certain altitude, such as a sea-level air pressure or air pressure found at an altitude of, for example, 6,000 feet (ft), or 8,000 ft, or 10,000 ft. For instance, air pressure at sea level may be about 101 kilo pascal (kPa), and air pressure at 8,000 ft altitude may be about 75 kPa. In an example, the pressurization system of the aircraft is designed to maintain a minimum pressure found generally at about 8,000 ft altitude, e.g., which is about 75 kilo pascal (kPa), for example, although other range of pressure may be possible and is implementation specific.

Thus, even if the height of the aircraft is above 8,000 ft, the pressurization system of the aircraft aims to regulate the air pressure within the aircraft to be at about 75 kPa. So, even if the aircraft is flying at altitude 8,000 ft or higher (e.g., 15,000 ft or 20,000 ft), the sense signal described above would indicate a pressure of 75 kPa and/or an altitude of 8,000 ft, because the internal section of the aircraft and the enclosure is pressurized to 75 kPa, for example. Note that in an example, if the aircraft is flying at an altitude lower than 8,000 ft, the air pressure within the aircraft may be higher than 75 kPa, e.g., as the outside air pressure at that altitude may be higher than 75 kPa.

The battery assembly may not be operated safely at low air pressure, e.g., when the air pressure within the enclosure is less than a threshold air pressure, due to higher electrical conductivity of air at this low air pressure. This threshold air pressure may be based on, for example, the above described clearance w1 and/or the voltage level of the battery cells, and may be implementation specific. As an example, assume that the threshold air pressure is about 58 kPa, which is generally the air pressure at about 15,000 ft altitude. This example altitude of 15,000 ft is the threshold altitude. Thus, if the air pressure within the aircraft (and within the enclosure) falls below 58 kPa, the battery assembly may no longer be safe to operate.

Now, in an event of a depressurization event, the pressure regulation system can no longer effectively control the pressure inside the aircraft. In one example, the depressurization event may occur at sufficiently lower altitude, such as lower than the threshold altitude (which is 15,000 ft in the above described example). For example, assume depressurization event occurs at an altitude of 12,000 ft, and at this altitude, the outside air pressure is about 64 kPa (for example). Due to the depressurization event, the inside air pressure tends to equate to the outside air pressure. Accordingly, now the inside of the aircraft, as well as the inside of the enclosure, the air pressure is at about 64 kPa pressure, which is still higher than the example threshold pressure of 58 kPa. In one example, the sense signal indicates the air pressure of 64 kPa. Additionally, or alternatively, the sense signal may also indicate the corresponding altitude of 12,000 ft (e.g., where the altitude may be derived from the sensed air pressure). Thus, because the sensed air pressure is higher than the threshold air pressure and/or the sensed altitude is lower than the threshold altitude, the battery assembly remains operational, and the intermediate switch and the first and second end switches remain closed, e.g., as also described below with respect to FIG. 3.

In another example scenario, the depressurization event may occur at sufficiently higher altitude, such as higher than the threshold altitude (which is 15,000 ft in the above described example). For example, assume depressurization event occurs at an altitude of 20,000 ft, and at this altitude, the outside air pressure is about 46 kPa. Accordingly, now the inside of the aircraft, as well as the inside of the enclosure, the air pressure is at 46 kPa pressure, which is lower than the above described example threshold pressure of 58 kPa, and the 20,000 altitude is higher than the threshold altitude of 15,000 ft. In one example, the sense signal indicates the air pressure of 46 kPa. Additionally, or alternatively, the sense signal may also indicate the corresponding altitude of 20,000 ft (e.g., where the altitude may be derived from the sensed air pressure). Thus, because the sensed air pressure is lower than the threshold air pressure and/or the sensed altitude is higher than the threshold altitude, the battery assembly may no longer be safely operated, due to the clearance w1 being insufficient to prevent arcing or shorting between the battery terminals of the battery assembly and the enclosure at such low air pressure (low pressure air has better electrical conductivity, as described above). In one embodiment, a controller (which may be internal to the enclosure, or may be replaced by a control system external to the enclosure) receives the sense signal indicating that the sensed air pressure is lower than the threshold air pressure and/or the sensed altitude is higher than the threshold altitude, and issues control signals to open one or more of switches. For instance, the first end switch and the second end switch may be opened by the controller, thereby disconnecting the battery cells from the load. In some such cases, even though the first one or more battery cells and the second one or more battery cells are no longer connected to the load (e.g., disconnected due to opening of the two end switches), the series connection of the first one or more battery cells and the second one or more battery cells may still have sufficient potential to result in arcing or electrical shorting between the battery terminals and the enclosure, e.g., due to (i) the small clearance of w1 between the battery terminals and the enclosure and (ii) the low air pressure having the relatively higher conductivity. Accordingly, in one embodiment, in addition to opening the first and second end switches, the intermediate switch is also opened during the above described example depressurization event.

Opening the intermediate switch divides the series connected battery cells into two separate, disconnected, and disjoint groups of battery cells, e.g., the first one or more battery cells and the second one or more battery cells. This reduces the voltage of each such group of battery cells, thereby eliminating or reducing chances of the above described arcing or shorting between the battery terminals and the enclosure. Moreover, if an arcing or electrical shorting between a battery cell and the enclosure does occur, such arcing or electrical shorting may be less severe (e.g., compared to a situation when the intermediate switch is not open), due to the lower voltage available to each group of battery cells.

In accordance with some embodiments of the present disclosure, these various approaches can be used individually or together to eliminate or reduce chances of arcing or shorting between the battery terminals and the enclosure. Numerous variations and embodiments will be apparent in light of the present disclosure.

As used herein, the term “about” indicates that the value listed may be somewhat altered or otherwise within an acceptable tolerance, as long as the alteration does not result in nonconformance of the process or device. For example, for some elements the term “about” can refer to a variation of +0.1%, for other elements, the term “about” can refer to a variation of +1% or #10%, or any point therein. As also used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes all whole and real numbers of 50 and greater, and reference herein to a range of “less than 50” or “less than about 50” includes all whole real numbers 49 and lower.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

### Architecture

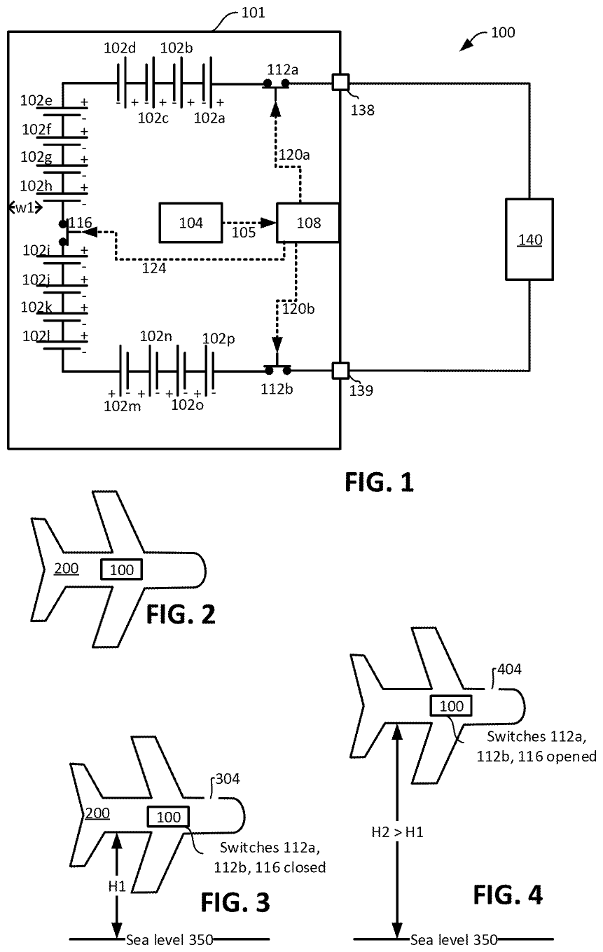

FIG. 1 illustrates a battery assembly 100 comprising a plurality of battery cells 102a, . . . , 102p within an enclosure 101, wherein the plurality of battery cells 102a, . . . , 102p are arranged in series, wherein the plurality of battery cells 102a, . . . , 102p includes first one or more battery cells 102a, . . . , 102h and second one or more battery cells 102i, . . . , 102p, and wherein the battery assembly 100 comprises a switch 116 between the first one or more battery cells 102a, . . . , 102h and the second one or more battery cells 102i, . . . , 102p, and wherein the switch 116 is turned off in response to an air pressure within the enclosure 101 falling below a threshold pressure value, in accordance with an embodiment of the present disclosure.

In some examples, the walls of the enclosure 101 comprise metal, while in some other examples the walls of the enclosure 101 comprise non-metal. In an example, the walls of the enclosure 101 comprise a combination of metal and non-metal. In an example, the enclosure 101 is somewhat air-tight, but may have vents or openings, e.g., to allow the enclosure 101 and the battery cells 102a, . . . , 102p to “breathe,” e.g., to gradually exchange air or gas with the ambient (e.g., space outside the enclosure 101). Thus, for example, if the air pressure outside the enclosure 101 falls, the air pressure inside the enclosure 101 may correspondingly fall, albeit after some time delay.

In one embodiment, individual battery cells 102 may comprise of any appropriate type of battery cell. For example, individual battery cells 102 may comprise lithium ion battery cells, although the battery cells 102 may be of another appropriate type, such as lead acid battery cells, or hydrogen cells. In an example, the battery cells 102a, . . . , 102n may be of appropriate size and may have any appropriate shape or form factor. In one embodiment, each battery cell 102 includes an electrolyte within a corresponding container, although the electrolyte and the containers of the battery cells 102 are not illustrated in FIG. 1.

In one embodiment, the switch 116 is between the first one or more battery cells 102a, . . . , 102h and the second one or more battery cells 102i, . . . , 102p. Thus, the switch 116, the first one or more battery cells 102a, . . . , 102h, and the second one or more battery cells 102i, . . . , 102p are in series.

In the example of FIG. 1, there are sixteen battery cells 102a, . . . , 102p, with eight battery cells 102a, . . . , 102h on one side of the switch 116 and eight other battery cells 102i, . . . , 102p on another side of the switch 116. Thus, in the example of FIG. 1, there are equal number of battery cells on two sides of the switch 116. In one example, the switch 116 is placed in the middle of the series connected battery cells, such that there are equal number of battery cells on each side of the switch 116. In another example, the switch 116 is placed about in the middle of the series connected battery cells, such that the number of battery cells on each side of the switch 116 differs by at most one, or at most two, or at most three. For example, there may be unequal numbers of battery cells on two sides of the switch 116. In an example where there are 16 total battery cells, there may be 7 battery cells on one side of the switch 116 and 9 cells on another side of the switch 116, or 10 battery cells on one side of the switch 116 and 6 cells on another side of the switch 116, and so on.

The series connected battery cells 102a, . . . , 102p (e.g., connected through the switch 116) is coupled to a load 140, e.g., through load terminals (also referred to as connectors) 138 and 139 of the enclosure 101. In an example, the load 140 is external to the enclosure 101. The load 140 may be any appropriate load that may be driven by the battery cells 102a, . . . , 102p.

In one embodiment, the positive end of the battery cells 102a, . . . , 102p is coupled to the load 140 through a switch 112a and the load terminal 138 of the enclosure 101, and the negative end of the battery cells 102a, . . . , 102p is coupled to the load 140 through a switch 112b and the load terminal 139 of the enclosure 101. Thus, the switch 112a, the first one or more battery cells 102a, . . . , 102h, the switch 116, the second one or more battery cells 102i, . . . , 102p, and the switch 112b are in series, and the series connected battery cells and the switches are connected to the load 140.

In one embodiment, a controller 108 controls the switches 112a, 112b, 116 using control signals 120a, 120b, and 124, respectively. For example, the controller 108 can control a state of the switch 112a (e.g., open or close the switch 112a) using the control signal 120a. Similarly, the controller 108 can control a state of the switch 112b (e.g., open or close the switch 112b) using the control signal 120b. Similarly, the controller 108 can control a state of the switch 116 (e.g., open or close the switch 116) using the control signal 124. The control signals 120a, 120b, 124 are illustrated using dotted lines, e.g., to better differentiate the control signals from the connections of the battery cells 102.

In an example, the controller 108 is implemented using a processor, such as a microcontroller. Although not illustrated, in an example, the processor may be coupled to a communication chip, e.g., for communicating with a sensor 104 and/or the switches 112a, 112b, 116. In one embodiment, the processor is coupled to a computer readable storage medium (not illustrated in FIG. 1), such as a memory or a data storage device that is also within the enclosure 101. In one embodiment, the computer-readable storage medium stores instructions or codes, which, when executed by the processor 108, cause the processor 108 to perform operations to control the switches 112a, 112b, and/or 116. In one embodiment, the processor 108 and/or the memory are on a printed circuit board (PCB), where the PCB is mounted within the enclosure 101. In another example, the controller 108 is implemented using another appropriate hardware circuitry.

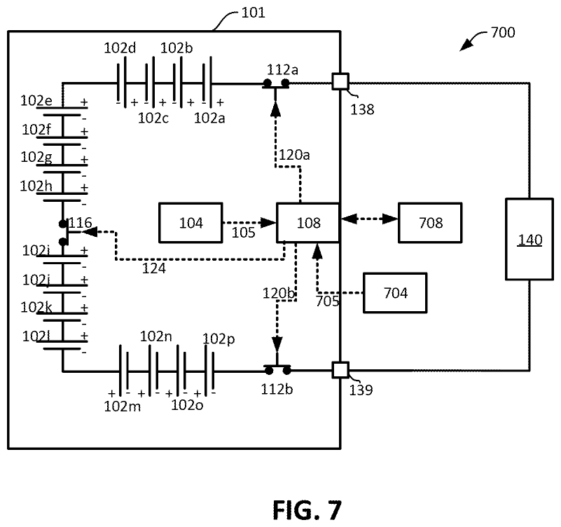

In some embodiments, the battery assembly 100 includes a sensor 104, which may be an air pressure sensor (such as a barometric pressure sensor) in an example. In some such embodiments, the sensor 104 is within the enclosure 101, although in some other embodiments, the sensor 104 may be external to the enclosure 101 as well (e.g., see sensor 704 of FIG. 7). The sensor 104 monitors the air pressure within the enclosure 101. A sense signal 105 generated by the sensor 104 is received by the controller 108.

As will be described herein below, atmospheric pressure reduces with a gain in altitude. For example, atmospheric pressure at 10,000 ft is less than the atmospheric pressure at sea level. In an example, in addition to, or instead of, providing an indication of air pressure, the sensor 104 (and/or a sensor circuitry coupled to the sensor 104) may provide an altitude of the battery assembly as well. Thus, the sensor circuitry may translate or correlate a detected air pressure to a corresponding altitude, and may provide an indication of the altitude of the battery assembly.

As schematically illustrated in FIG. 1, one or more battery terminals (e.g., positive and/or negative terminals) of one or more battery cells 102 has a clearance of about “w1” from the enclosure 101. Thus, the battery terminals are separated from an inner wall of the enclosure 101 (or another conductive surface attached to the enclosure 101) by a clearance distance of w1. In an example, the distance w1 may be an average distance between the battery terminals and the enclosure 101. In another example, the distance w1 may be a minimum or lowest distance between one or more battery terminals and the enclosure 101.

In an example, the clearance distance w1 may be sufficient to avoid arcing or unintentional electrical shorting between the battery terminals and the enclosure 101, e.g., during “normal operating conditions” of the battery assembly 100, where “normal operating conditions” of the battery assembly 100 implies operating the battery assembly 100 at or above a threshold air pressure value.

For example, air is generally present between the battery terminals and the enclosure 101. At sea-level air pressure, or at an air pressure present at an altitude that is below a threshold altitude (such as 15,000 ft, for example), the distance w1 may be sufficient to avoid arcing or unintentional electrical shorting between the battery terminals and the enclosure 101. Thus, for example, the battery assembly 100, including the clearance w1, may be designed and rated for sea-level air pressure, or at an air pressure present at a relatively low altitude, such as below the threshold altitude.

However, as and when the pressure of the air decreases (e.g., with an increase in altitude, or due to a depressurization event in an aircraft), conductivity of air increases. Thus, at a low air pressure (e.g., below a threshold air pressure level), the air between the battery terminals and the enclosure 101 has a higher conductivity (e.g., compared to a conductivity of the air at a pressure above the threshold air pressure level). Accordingly, chances of arcing or unintentional electrical shorting between the battery terminals and the enclosure 101 increases, with a decrease in air pressure within the enclosure 101.

Accordingly, in one embodiment, the controller 108 controls the state of the switch 116 (and also optionally the state of the switches 112a, 112b), e.g., based at least in part on the sense signal 105 that is generated by the sensor 104 and that is indicative of air pressure within the enclosure 101 and/or altitude of the enclosure 101 (where the altitude may be estimated by measuring the air pressure), as described herein. For example, when the air pressure falls below the above discussed threshold air pressure level (or the altitude goes above the threshold altitude), the switches 112a, 112b, and/or 116 are opened by the controller 108, e.g., to eliminate or reduce changes of arcing or unintentional electrical shorting between the battery terminals and the enclosure 101.

FIG. 2 illustrates the battery assembly 100 installed in an aircraft 200, in accordance with an embodiment of the present disclosure. In an example, the battery assembly 100 may be installed in any appropriate type of aircraft, such as an airplane or a helicopter, an unmanned aerial vehicle (UAV), a missile system, a space craft, or another powered air vehicle.

For example, the battery assembly 100 is installed in an area of the aircraft 200, in which air pressure (and possibly the temperature) is regulated. For example, as and when the aircraft 200 gains altitude, the air pressure outside the aircraft decreases. Accordingly, without pressure regulation, air pressure within the aircraft would also decrease correspondingly, e.g., causing discomfort for the passengers and/or causing adverse issues to one or more elements inside the pressure regulated sections of the aircraft.

Accordingly, in some examples, air pressure is regulated inside at least some sections of the aircraft 200, such that the air pressure is maintained at somewhat constant level, e.g., is maintained within a target pressure range, within such sections of the aircraft 200. In an example, the air pressure within such sections of the aircraft 200 is maintained substantially to an air pressure typically found at a certain altitude or a range of altitudes, such as at 6,000 feet (ft), or 8,0000 ft, or 10,000 ft, or another appropriate altitude or ranges of altitude (or may be even maintained at an air pressure of sea level).

As an example, air pressure at sea level may be about 101 kilo pascal (kPa), and air pressure at 8,000 ft altitude may be about 75 kPa (note that the actual pressure values and altitude values presented herein are mere examples). The pressurization system of the aircraft 200 may be designed to maintain a pressure typically found at around 8,000 ft altitude (for example), e.g., at about 75 kPa. Thus, even if the height of the aircraft is above 8,000 ft, the pressurization system of the aircraft 200 aims to regulate the air pressure within the aircraft to be at about 75 kPa. In an example, there may be some variations of the air pressure within the air pressure regulated section (e.g., varying between 101 to 70 kPa); but if successfully regulated, the air pressure within the regulated section may not go below 75 kPa or 70 kPa, merely as an example.

As an example, and without limiting the scope of his disclosure, it is assumed that the air pressure within the aircraft 200 is maintained at 75 kPa, e.g., a pressure typically found at around 8,000 ft altitude. However, such numbers are mere examples, and the air pressure may be regulated at anther appropriate pressure level as well.

Thus, when the air pressure is successfully regulated within the aircraft 200, the sensor 104 outputs an air pressure of about 75 kPa, even if the air pressure outside the aircraft is less than 75 kPa.

In an example, in addition to, or instead of, providing an indication of pressure, the sensor 104 (and/or a sensor circuitry coupled to the sensor 104) may also provide an altitude of the battery assembly 100. For example, the sensor circuitry may translate or correlate a detected air pressure within the enclosure 101 to a corresponding altitude, and may provide an indication of the altitude of the battery assembly. Thus, the sensor 104 may provide an altitude of 8,000 ft, even if the aircraft 200 may be flying at a much higher altitude, such as at 15,000 ft or 20,000 ft altitude, for example.

As an example, and without limiting the scope of his disclosure, the threshold air pressure to activate the switches 116, 112a, and/or 112b may be assumed to be about 58 kPa, e.g., air pressure typically found at 15,000 ft (which may be the threshold altitude value). Thus, if the pressure sensed by the sensor 104 is less than 58 kPa and/or an altitude sensed by the sensor 104 is higher than 15,000 ft, the controller 108 activates (e.g., opens) the switches 116, 112a, and/or 112b, as will be described herein.

In an example, the threshold air pressure and the threshold altitude may be implementation specific, and may depend on a variety of factors, such as the clearance distance w1, actual voltage supplied by the battery cells 102, and/or one or more other relevant factors.

FIG. 3 illustrates a de-pressurization event in the aircraft 200 of FIG. 2, e.g., when the aircraft 200 is at a first altitude H1, in accordance with an embodiment of the present disclosure. FIG. 4 illustrates a de-pressurization event in the aircraft 200 of FIG. 2, e.g., when the aircraft 200 is at a second altitude H2 that is higher than the first altitude H1 of FIG. 3, in accordance with an embodiment of the present disclosure.

Referring to FIG. 3, the aircraft 200 is at the first altitude or height H1 from a sea level 350, and the de-pressurization event occurs. The de-pressurization event is an unintentional event when the pressurized sections of the aircraft 200 (e.g., sections of the aircraft 200 in which the pressure is regulated) loses air pressure. The de-pressurization event may be, for example, due to a fault in a mechanism used to regulate the air pressure within the aircraft 200. In another example, the de-pressurization event may be due to a relatively large opening 304 that may have been unintentionally formed on a body of the aircraft 200 (e.g., due to an accident or a crack on the aircraft body).

In any such case where the de-pressurization event occurs, the air pressure within the aircraft 200 may no longer be effectively regulated. Based on a severity of the de-pressurization event, the air pressure inside the aircraft 200 tends to be approach the air pressure outside the aircraft 200. Also, as the altitude of the aircraft 200 increases, the air pressure outside the aircraft 200 decreases. Accordingly, the air pressure outside the aircraft 200, at altitude H1, may be lower that the air pressure at sea level.

In an example where the de-pressurization event is relatively less severe (e.g., the pressure regulator mechanism is partially functioning, or there is a small crack within the body of the aircraft), the air pressure within the aircraft 200 may be somewhat regulated. However, if the de-pressurization event is relatively more severe (e.g., the pressure regulator mechanism is non-functional, or there is a large crack within the body of the aircraft), the air pressure within the aircraft 200 may not be regulated at all.

Accordingly, depending on the altitude H1 (and the corresponding air pressure outside the aircraft 200 at altitude H1) and/or the severity of the de-pressurization event, the air pressure inside the aircraft 200 decreases. With a decrease of the air pressure inside the aircraft 200, the air pressure inside the enclosure 101 also correspondingly decreases. The sensor 104 senses the air pressure inside the enclosure 101, and indicates the air pressure inside the enclosure 101 through the sense signal 105.

Note that if the aircraft 200 is at a lower altitude (e.g., altitude H1 is less than 8,000 ft, for the above described example where air pressure inside the aircraft is regulated at 75 kPa that may be found at 8,000 ft), then there may not be a depressurization or lowering of pressure within the aircraft 200.

In the example of FIG. 3, the air pressure inside the aircraft 200, and accordingly inside the enclosure 101 as well, may be still higher than the above described threshold air pressure (e.g., which is 58 kPa or pressure found at 15,000 ft altitude, in the example described herein above). Hence, at altitude H1, it may still be safe to operate the battery assembly (e.g., chances of arcing or unintentional electrical shorting between the battery terminals and the enclosure 101 may still be within acceptable range). For example, altitude H1 may be less than the threshold altitude of 15,000, and hence, air pressure within the enclosure 101 may be higher than the threshold pressure of about 58 kPa. Thus, the sense signal 105 may indicate the air pressure inside the enclosure 101 to be higher than the threshold air pressure and/or the altitude to be lower than the threshold altitude. Accordingly, the switches 112a, 112b, 116 may remain closed, and the battery assembly may operate as usual, e.g., continuing to supply power to the load 140.

Referring now to FIG. 4, the aircraft 200 is at the second altitude or height H2 from the sea level 350, and a de-pressurization event occurs within the aircraft 200. Thus, similar to FIG. 3, in the scenario of FIG. 4, the air pressure within the aircraft 200 may no longer be effectively regulated.

Depending on the altitude H2 (and the corresponding air pressure outside the aircraft 200 at altitude H2) and/or the severity of the de-pressurization event, the air pressure inside the aircraft 200 decreases. With a decrease of the air pressure inside the aircraft 200, the air pressure inside the enclosure 101 also correspondingly decreases. The sensor 104 senses the air pressure inside the enclosure 101, and indicates the air pressure inside the enclosure 101 through the sense signal 105.

The height H2 of the example FIG. 4 may be higher than the height H1 of the example FIG. 3. In the example of FIG. 4, the air pressure inside the aircraft 200, and accordingly inside the enclosure 101 as well, may be lower than the above described threshold air pressure (e.g., which is 58 kPa or pressure found at 15,000 ft altitude, in the example described herein above). For example, the altitude H2 may be more than the threshold altitude of 15,000, and hence, air pressure within the enclosure 101 may fall below the threshold pressure of about 58 kPa, due to the depressurization event.

Hence, it may no longer be safe to operate the battery assembly, as chances of arcing or unintentional electrical shorting between the battery terminals and the enclosure 101 may be outside the acceptable range due to the low air pressure within the enclosure 101. For example, the sense signal 105 may indicate the air pressure inside the enclosure 101 to be lower than the threshold air pressure and/or the altitude to be higher than the threshold altitude. Accordingly, one or more of the switches 112a, 112b, 116 may be opened by the controller 108, e.g., using the control signals 120a, 120b, and/or 124, respectively. Thus, the battery assembly ceases to supply power to the load 140 in the example of FIG. 4.

In the example scenario described with respect to FIG. 4, opening the switch 112a and/or 112b effectively cuts off the battery cells 102a, . . . , 102p from the load 140. Thus, the switch 116 does not contribute to disconnecting the battery cells 102a, . . . , 102p from the load 140. Rather, an opening of the switch 116 reduces a total potential level provided by the battery cells 102a, . . . . 102p, e.g., by breaking the series connection of the battery cells 102a, . . . , 102p into two isolated series connections comprising the first battery cells 102a, . . . , 102h, and the second battery cells 102i, . . . , 102p. In one embodiment, breaking the series connection of the battery cells 102a, . . . , 102p into two isolated series connections reduces chances of high voltage arcing within the enclosure 101.

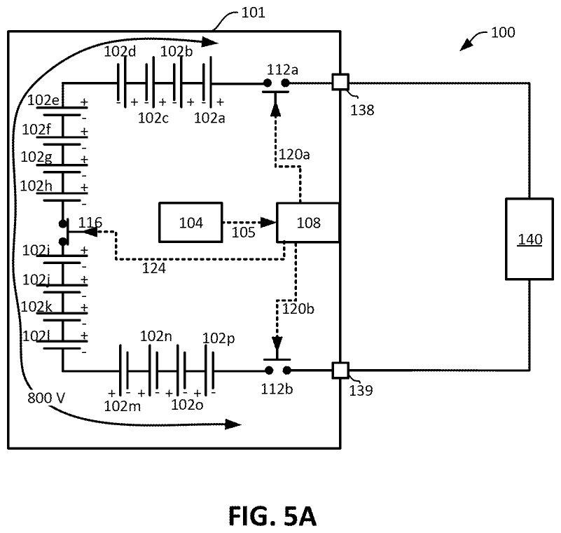

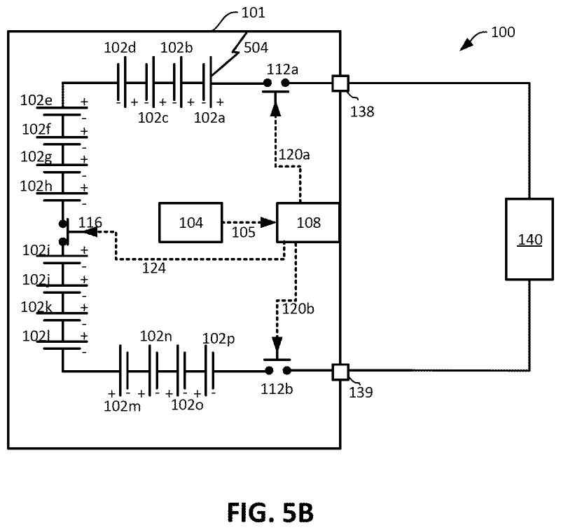

FIGS. 5A and 5B illustrate fault scenarios occurring when the switch 116 between the first one or more battery cells 102a, . . . , 102h and the second one or more battery cells 102i, . . . , 102p of FIG. 1 is closed, when the battery cells 102a, . . . , 102p are disconnected from the load 140 that is external to the enclosure 101, and when the air pressure within the enclosure is below the above described threshold air pressure, in accordance with an embodiment of the present disclosure.

For example, due to the depressurization event described with respect to FIG. 4, the sense signal 105 indicates the air pressure within the enclosure 101 to be below the threshold air pressure and/or the altitude to be higher than the threshold altitude. Accordingly, for safety reasons described above, the switches 112a and 112b are now open. However, because the switch 116 is still closed, the potential of the series connected entire battery pack is available for potential arcing or shorting with the enclosure 101. Furthermore, due to the depressurization event and consequent air pressure within the enclosure 101 being less than the threshold air pressure, chances of such potential arcing or shorting with the enclosure 101 increases beyond the acceptable risk level.

Merely as an example, assume that there are sixteen battery cells 102a, . . . , 102p, each having a voltage level of about 50 volts (V). Thus, in the example of FIGS. 5A and 5B, the series connected battery cells 102a, . . . , 102p have a combined potential of 16×50 V, e.g., 800V, as symbolically labelled in FIG. 5A.

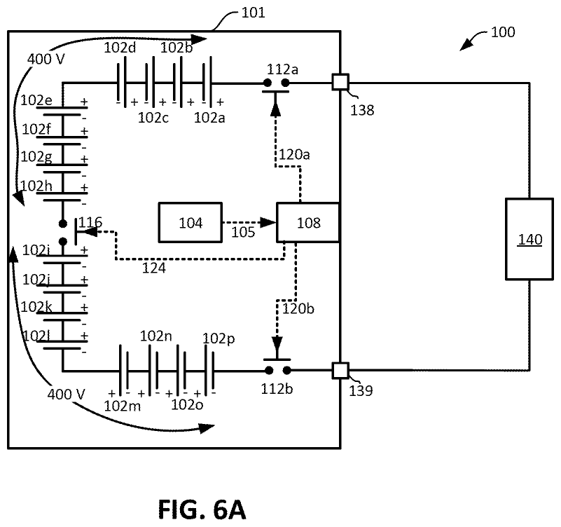

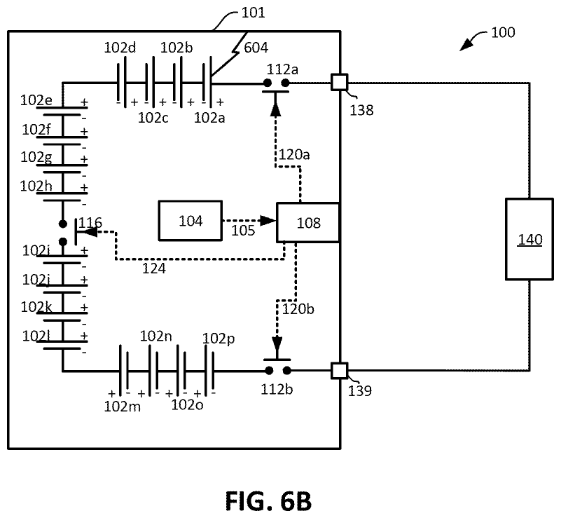

Furthermore, due to such relatively high 800 V potential level and due to the air pressure within the enclosure 101 being less than the threshold air pressure, chances of arcing increases even more. For example, FIG. 5B illustrates an arcing event 504 between the battery cell 102a and the enclosure 101. Thus, there are 16 series connected battery cells 102a, . . . , 102p, and hence, 16×50 V or 800 V potential level may be shorted to the enclosure 101, thereby generating a relatively higher (e.g., higher compared to the scenario of FIG. 6B) shorting current and consequent chances of fire hazard.

FIGS. 6A and 6B illustrate fault scenarios occurring when the switch 116 between the first one or more battery cells 102a, . . . , 102h and the second one or more battery cells 102i, . . . , 102p of FIG. 1 is open, and when the battery cells 102a, . . . , 102p are disconnected from the load 140 that is external to the enclosure 101, and when the air pressure within the enclosure is below the above described threshold air pressure, in accordance with an embodiment of the present disclosure.

Thus, in FIGS. 5A and 5B the switch 116 is closed, whereas in FIGS. 6A and 6B the switch 116 is open. Due to the opening of the switch 116, now the series of battery cells 102a, . . . , 102p are broken in two disconnected and disjoint series of battery cells, such as a first series of battery cells comprising battery cells 102a, . . . , 102h, and a second series of battery cells comprising battery cells 102i, . . . , 102p. Thus, due to the opening of the switch 116, the potential of only about half of the battery pack is available for potential arcing or shorting with the enclosure 101. For example, assuming that there are sixteen battery cells 102a, . . . , 102p and each having a voltage level of about 50 V, each of the above described first and second series of battery cells has a maximum potential of 8×50 V, e.g., 400V, as symbolically labelled in FIG. 6A. Furthermore, due to such relatively low 400 V potential level (e.g., low compared to the 800 V of FIGS. 5A and 5B), chances of arcing decreases (e.g., is lower compared to the scenario of FIGS. 5A and 5B). Furthermore, severity of an arcing, if an arcing occurs, also decreases (e.g., compared to the scenario of FIGS. 5A and 5B).

For example, FIG. 6B illustrates an arcing event 604 between the battery cell 102a and the enclosure 101. However, there are only 8 series connected battery cells 102a, . . . , 102p, and hence, 400 V potential level may be shorted to the enclosure 101, thereby generating a relatively lower (e.g., lower compared to the scenario of FIG. 5B) shorting current.

FIG. 7 illustrates a battery assembly 700 that is at least in part similar to the battery assembly of FIG. 1, and wherein the switch 116 between the first one or more battery cells 102a, . . . , 102h and the second one or more battery cells 102i, . . . , 102p is controlled by a controller 108 that is within the enclosure 101 and/or by a system 708 that is external to the enclosure 101, where the controlling of the switch 116 is based at least in part on a pressure sensor 104 that is within the enclosure 101 and/or a sensor 704 that is external to the enclosure 101, in accordance with an embodiment of the present disclosure.

Thus, in an example, the controlling of the switches 112a, 112b, 116 can be done by the processor 108 and/or by the system 7008. In an example, the system 708 comprises processor coupled to a computer readable storage medium (not illustrated in FIG. 7), such as a memory or a data storage device. In one embodiment, the computer-readable storage medium stores instructions or codes, which, when executed by the processor 708, cause the processor 708 to perform operations to control the switches 112a, 112b, and/or 116. In one embodiment, the processor 708 and/or the memory are on a PCB that is outside the enclosure 101. In an example, the system 708 may issue the control signals 120a, 120b, and/or 124, e.g., through the controller 108, or bypassing the controller 108 (although FIG. 7 doesn't illustrate the control signals 120a, 120b, and/or 124 being issued by the system 708 by bypassing the controller 108). In an example, a human user can interact with the system 708, e.g., to at least in part control the issuances of the control signals 120a, 120b, and/or 124, e.g., in an event of depressurization of the aircraft 200 and consequent pressure drop below the above described threshold pressure.

In FIG. 1, the sensor 104 was inside the enclosure 101. In contrast, in FIG. 1, the sensor 104 is inside the enclosure 101, and another similar (or different) sensor 704 is outside the enclosure 101. In an example, the battery assembly can include any one of the sensors 104 and 704, or both the sensors 104 and 704.

The controller 108 and/or the system 708 receives the sense signal 105 from the sensor 104 indicating the air pressure internal to the enclosure 101, and/or receives the sense signal 705 from the sensor 704 indicating the air pressure external to the enclosure 101. Based on the sense signals 105 and/or 705 indicating the air pressure to be less than the above described threshold pressure, the controller 108 and/or the system 708 issues the control signals 120a, 120b, and/or 124, to respectively open the switches 112a, 112b, and/or 116, as described herein above.

Note in in an example, in addition to or instead of indicating the air pressure, the sensors 104 and/or 704 may indicate an altitude of the aircraft 200, as also described herein above, and the controlling of the switches may be also based at least in part on such altitude readings.

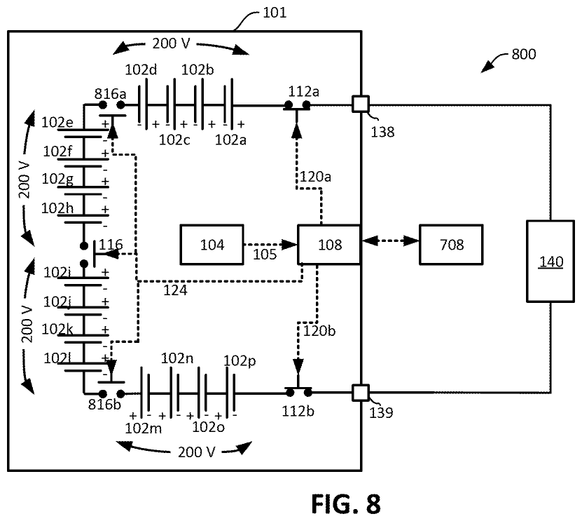

FIG. 8 illustrates a battery assembly 800 comprising a plurality of battery cells 102a, . . . , 102p within an enclosure 101, wherein the plurality of battery cells 102a, . . . , 102p are arranged in series, wherein the plurality of battery cells 102a, . . . , 102p includes (i) first one or more battery cells 102a, . . . , 102d, (ii) second one or more battery cells 102e, . . . , 102h, (iii) third one or more battery cells 102i, . . . , 1021, and (iv) fourth one or more battery cells 102m, . . . , 102p, and wherein the battery assembly 100 comprises (A) a first switch 816a between the first one or more battery cells 102a, . . . , 102d and the second one or more battery cells 102e, . . . , 102h, (B) a second switch 116 between the second one or more battery cells 102e, . . . , 102h and the third one or more battery cells 102i, . . . , 1021, and (C) a third switch 816b between the third one or more battery cells 102i, . . . , 1021 and the fourth one or more battery cells 102m, . . . , 102p, and wherein the first switch 116, the second switch 816a, and the third switch 816b are turned off in response to an air pressure within the enclosure 101 falling below a threshold pressure, in accordance with an embodiment of the present disclosure.

Thus, in the battery assembly 100 of FIG. 1, the battery cells 102a, . . . , 102p were divided into two groups, with the switch 116 between the two groups of battery cells, e.g., to disconnect the first group of battery cells 102a, . . . , 102h from the second group of battery cells 102i, . . . , 102p, thereby resulting in a maximum voltage of 400 V (for the example of FIG. 6A) in any of the first or second groups of battery cells (e.g., assuming 16 battery cells, with each battery cell having a voltage of 50 V).

In contrast, in the battery assembly 800 of FIG. 8, the battery cells 102a, . . . , 102p are divided into four groups, with each of the switches 816a, 116, 816b between two corresponding groups of battery cells, e.g., to disconnect each group of battery cells from the adjacent groups of battery cells. This results in a maximum voltage of 200 V in any of the first, second, third, or fourth groups of battery cells (e.g., assuming 16 battery cells, with each battery cell having a voltage of 50 V). This results in even lower voltage level for each battery groups, e.g., thereby further decreasing chances of arcing or unintentional electrical shorting between the battery terminals and the enclosure 101 and/or severity of any such arcing, e.g., compared to the single switch case where the single switch 116 is present in the battery assembly.

In another example, instead of one switch (e.g., switch 116 of FIG. 1) or three switches (e.g., switches 816a, 816b, 116 of FIG. 8), the battery assembly may include another appropriate number of switches (e.g., two, four, or higher) within the series of battery cells, to break down the battery cells into corresponding groups of disjoint and disconnected (e.g., if the switches are open) battery cells, as will be appreciated.

In FIG. 8, the switches 816a, 816b maybe controlled by the above described control signal 124, in an example. Operation of the switches 816a, 816b may be similar to the above described operation of the switch 116, in an example.

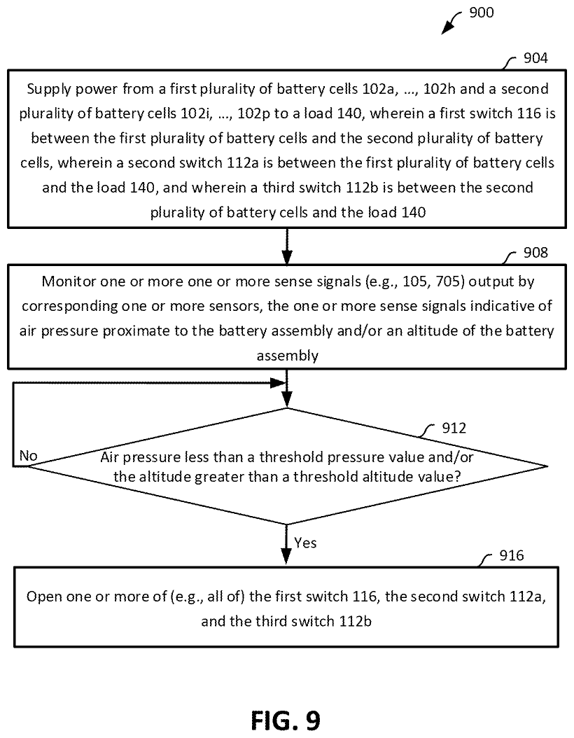

FIG. 9 illustrate a flowchart depicting a method 900 for operating any of the battery assemblies described herein, in accordance with an embodiment of the present disclosure. At 904 of the method 900, power is supplied from a first plurality of battery cells 102a, . . . , 102h and a second plurality of battery cells 102i, . . . , 102p to a load 140, e.g., see FIG. 1. A first switch 116 is between the first plurality of battery cells 102a, . . . , 102h and the second plurality of battery cells 102i, . . . , 102p. A second switch 112a is between the first plurality of battery cells 102a, . . . , 102h and the load 140. A third switch 112b is between the second plurality of battery cells 102i, . . . , 102p and the load 140, as described above. There may be additional switches, such as switches 816a and 816b, see FIG. 8.

The method 900 proceeds from 904 to 908, at which one or more one or more sense signals (e.g., sense signals 105 and/705) output by corresponding one or more sensors (e.g., sensors 104 and/or 704) are monitored. In an example, the one or more sense signals are indicative of air pressure proximate to the battery assembly and/or an altitude of the battery assembly. Air pressure proximate to the battery assembly is the air pressure within the enclosure 101 (e.g., as measured by the sensor 104), and/or the air pressure outside the enclosure 101 but within the pressure regulated section of the aircraft 200 (e.g., as measured by the sensor 704).

As the air pressure is regulated within the pressure regulated section of the aircraft 200 in which the battery assembly is installed, the air pressure will be as regulated by a pressurization system of the aircraft. For example, when the pressurization system is operational as intended, the air pressure is at least around a target air pressure, such as, for example, 75 kPa, which is the air pressure generally found at 8,000 ft altitude. In such an example, the altitude reading of the battery assembly would be 8,000 ft, even if the aircraft 200 is flying at a much higher altitude.

However, if the aircraft 200 encounters a depressurization event at a higher altitude (e.g., higher than 8,000 ft for the above described example scenario), the pressure within the pressure regulated section of the aircraft 200, as well as within the battery assembly, drops. Accordingly, the altitude reading also shows a corresponding higher altitude commensurate with the dropped air pressure level. If the air pressure falls below the threshold air pressure and/or the altitude reading is above the threshold altitude, the switches 112a, 112b, and/or 116 have to be opened, in an example.

The method 900 proceeds from 908 to 912, at which the controller 108 and/or the system 708 monitors if the air pressure is less than the threshold pressure value and/or the altitude reading is greater than the threshold altitude value, e.g., based on the monitored sense signals.

If “No” at 912, this indicates that no depressurization event has occurred. A “No” in 912 may also be possible if a depressurization event has occurred, but at a lower altitude, due to which there is not sufficient drop in air pressure. Accordingly, if “No” at 912, the method 900 loops back to 908, where the monitoring of the sense signals continues.

If “Yes” at 912, this indicates that a depressurization event has occurred at a sufficiently high altitude, and the air pressure within the enclosure 101 has dropped to an extent such that it is no longer safe to operate the battery assembly. Accordingly, the method proceeds from 912 to 916. At 916, one or more of (e.g., all of) the first switch 116, the second switch 112a, and the third switch 112b are opened (e.g., by the controller 108 and/or the system 708, using the respective control signals 124, 120a, 120b). This eliminates or reduces chances of electrical arcing (as well as severity of an electrical arcing, if such an electrical arcing occurs) within the battery assembly, thereby preventing fire hazards and/or other potential hazards that may occur due to any such electrical arcing, as described above.

Note that the processes in method 900 are shown in a particular order for ease of description. However, one or more of the processes may be performed in a different order or may not be performed at all (and thus be optional), in accordance with some embodiments. Numerous variations on method 900 and the techniques described herein will be apparent in light of this disclosure.

### Further Example Embodiments

The following examples pertain to further embodiments, from which numerous permutations and configurations will be apparent.

Example 1. A battery assembly comprising: a first plurality of battery cells, a second plurality of battery cells, and a switch between the first plurality of battery cells and the second plurality of battery cells, such that the first plurality of battery cells, the switch, and the second plurality of battery cells are connected in series to a load; and a controller configured to open the switch and the disconnect the first plurality of battery cells from the second plurality of battery cells, in response to air pressure proximal to the first and second pluralities of battery cells falling below a threshold level.

Example 2. The battery assembly of example 1, further comprising: a sensor configured to monitor the air pressure proximal to the first and second pluralities of battery cells and to output a sense signal; wherein the controller is configured to open the switch and the disconnect the first plurality of battery cells from the second plurality of battery cells, based at least in part on the sense signal.

Example 3. The battery assembly of any one of examples 1-2, further comprising: a sensor circuit to monitor the air pressure proximal to the first and second pluralities of battery cells and output a sense signal, the sense signal indicative of an altitude of the battery assembly, wherein the altitude of the battery assembly is based on the air pressure proximal to the first and second pluralities of battery cells; wherein the controller is configured to open the switch and the disconnect the first plurality of battery cells from the second plurality of battery cells, based at least in part on the sense signal being indicative of the sensed altitude to be higher than a threshold altitude.

Example 4. The battery assembly of any one of examples 1-3, wherein the switch is a first switch, and wherein the battery assembly further comprises: a second switch between the first plurality of battery cells and a first load terminal configured to be connected to the load; and a third switch between the second plurality of battery cells and a second load terminal configured to be connected to the load, such that the second switch, the first plurality of battery cells, the first switch, the second plurality of battery cells, and the third switch are configured to be connected in series between the first and second load terminals.

Example 5. The battery assembly of example 4, wherein the controller is further configured to control the second and third switches, based at least in part on the air pressure proximal to the first and second pluralities of battery cells.

Example 6. The battery assembly of any one of examples 1-5, further comprising: an enclosure to hold the first and second pluralities of battery cells, wherein the enclosure includes one or more load terminals configured for coupling with the load.

Example 7. The battery assembly of example 6, wherein the controller is within the enclosure.

Example 8. The battery assembly of any one of examples 6-7, further comprising: a sensor configured to monitor the air pressure proximal to the first and second pluralities of battery cells and to output a sense signal; wherein the sensor is within the enclosure.

Example 9. The battery assembly of any one of examples 6-8, wherein the air pressure proximal to the first and second pluralities of battery cells is an air pressure within the enclosure.

Example 10. A method of operating a battery assembly, the method comprising: supplying power from a first plurality of battery cells and a second plurality of battery cells to a load, wherein a first switch is between the first plurality of battery cells and the second plurality of battery cells, wherein a second switch is between the first plurality of battery cells and the load, and wherein a third switch is between the second plurality of battery cells and the load; monitoring one or more sense signals output by corresponding one or more sensors, the one or more sense signals indicative of air pressure proximate to the battery assembly and/or an altitude of the battery assembly; and controlling the first, second, and third switches, based at least in part on the one or more sense signals.

Example 11. The method of example 10, wherein controlling the first, second, and third switches comprises: in response to the air pressure being less than a threshold pressure value and/or the altitude being greater than a threshold altitude value, opening one or more of the first, second, and third switches.

Example 12. The method of any one of examples 10-11, further comprising: installing the battery assembly within an aircraft; responsive to a depressurization event within the aircraft when the aircraft is at or higher than a threshold altitude, indicating, by the one or more one or more sense signals output by corresponding the one or more sensors, the air pressure to be less than a threshold pressure value and/or the altitude to be greater than a threshold altitude value; and opening one or more of the first, second, and third switches, based on the one or more sense signals indicative of the air pressure being less than the threshold pressure value and/or the altitude being greater than the threshold altitude value.

Example 13. The method of any one of examples 10-12, further comprising: installing the battery assembly within a section of an aircraft; and regulating air pressure within the section of the aircraft.

Example 14. The method of any one of examples 10-12, wherein a first number of battery cells in the first plurality of battery cells and a second number of battery cells in the second plurality of battery cells are equal, or differ by at most two.

Example 15. The method of any one of examples 10-14, wherein the first plurality of battery cells and the second plurality of battery cells are within an enclosure, and wherein the method further comprises: installing the enclosure including the first and second plurality of battery cells within an aircraft; wherein monitoring the one or more sense signals comprises sensing, by a pressure sensor of the one or more sensors, the air pressure within the enclosure, and monitoring a sense signal output by the pressure sensor.

Example 16. The method of any one of examples 10-15, wherein the first plurality of battery cells and the second plurality of battery cells are within an enclosure, and wherein the method further comprises: installing the enclosure including the first and second plurality of battery cells within an aircraft; wherein monitoring the one or more sense signals comprises sensing, by a sensor of the one or more sensors, an altitude of the enclosure, based on the air pressure within the enclosure, and monitoring a sense signal output by the sensor.

Example 17. A system comprising: an aircraft; a plurality of battery cells comprising first one or more battery cells and second one or more battery cells, the plurality of battery cells within the aircraft, wherein the aircraft is fully or at least partially powered by the plurality of battery cells; a sensor configured to output a sense signal that is indicative of air pressure proximal to plurality of battery cells; and a controller configured to, in response to the sense signal indicative of the air pressure being less than a threshold value, disconnect the first one or more battery cells from the second one or more battery cells.

Example 18. The system of example 17, further comprising: a switch between the first one or more battery cells and the second one or more battery cells; wherein to disconnect the first one or more battery cells from the second one or more battery cells, the controller is configured to issue a control signal that causes the switch to transition to an open state.

Example 19. The system of any one of examples 17-18, further comprising: a first switch and a second switch; and a first load terminal and second load terminal, wherein the plurality of battery cells is coupled to the first and second load terminals through the first switch and the second switch, respectively, wherein the controller is further configured to, in response to the sense signal indicative of the air pressure being less than the threshold value, issue one or more control signals that cause the first and second switch to transition to an open state.

Example 20. The system of any one of examples 17-19, further comprising: an enclosure, wherein the plurality of battery cells and the sensor are within the enclosure, and the enclosure is within the aircraft, wherein the sense signal is indicative of the air pressure within the enclosure.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A battery assembly comprising:
a first plurality of battery cells, a second plurality of battery cells, and a switch between the first plurality of battery cells and the second plurality of battery cells, such that the first plurality of battery cells, the switch, and the second plurality of battery cells are connected in series to a load; and
a controller configured to open the switch and the disconnect the first plurality of battery cells from the second plurality of battery cells, in response to air pressure proximal to the first and second pluralities of battery cells falling below a threshold level.

2. The battery assembly of claim 1, further comprising:
a sensor configured to monitor the air pressure proximal to the first and second pluralities of battery cells and to output a sense signal;
wherein the controller is configured to open the switch and the disconnect the first plurality of battery cells from the second plurality of battery cells, based at least in part on the sense signal.

3. The battery assembly of claim 1, further comprising:
a sensor circuit to monitor the air pressure proximal to the first and second pluralities of battery cells and output a sense signal, the sense signal indicative of an altitude of the battery assembly, wherein the altitude of the battery assembly is based on the air pressure proximal to the first and second pluralities of battery cells;
wherein the controller is configured to open the switch and the disconnect the first plurality of battery cells from the second plurality of battery cells, based at least in part on the sense signal being indicative of the sensed altitude to be higher than a threshold altitude.

4. The battery assembly of claim 1, wherein the switch is a first switch, and wherein the battery assembly further comprises:
a second switch between the first plurality of battery cells and a first load terminal configured to be connected to the load; and
a third switch between the second plurality of battery cells and a second load terminal configured to be connected to the load, such that the second switch, the first plurality of battery cells, the first switch, the second plurality of battery cells, and the third switch are configured to be connected in series between the first and second load terminals.

5. The battery assembly of claim 4, wherein the controller is further configured to control the second and third switches, based at least in part on the air pressure proximal to the first and second pluralities of battery cells.

6. The battery assembly of claim 1, further comprising:
an enclosure to hold the first and second pluralities of battery cells, wherein the enclosure includes one or more load terminals configured for coupling with the load.

7. The battery assembly of claim 6, wherein the controller is within the enclosure.

8. The battery assembly of claim 6, further comprising:
a sensor configured to monitor the air pressure proximal to the first and second pluralities of battery cells and to output a sense signal;
wherein the sensor is within the enclosure.

9. The battery assembly of claim 6, wherein the air pressure proximal to the first and second pluralities of battery cells is an air pressure within the enclosure.

10. A method of operating a battery assembly, the method comprising:
supplying power from a first plurality of battery cells and a second plurality of battery cells to a load, wherein a first switch is between the first plurality of battery cells and the second plurality of battery cells, wherein a second switch is between the first plurality of battery cells and the load, and wherein a third switch is between the second plurality of battery cells and the load;
monitoring one or more sense signals output by corresponding one or more sensors, the one or more sense signals indicative of air pressure proximate to the battery assembly and/or an altitude of the battery assembly; and
controlling the first, second, and third switches, based at least in part on the one or more sense signals.

11. The method of claim 10, wherein controlling the first, second, and third switches comprises:
in response to the air pressure being less than a threshold pressure value and/or the altitude being greater than a threshold altitude value, opening one or more of the first, second, and third switches.

12. The method of claim 10, wherein:
the battery assembly is located within an aircraft;
the one or more sensors are configured to output the one or more sense signals indicative of a pressure event when the air pressure is outside of a predetermined range and/or the altitude is outside a predetermined range; and
one or more of the first, second, and third switches are controllable based on the one or more sense signals indicative of the air pressure being outside the predetermined pressure range and/or the altitude being outside the predetermined altitude range.

13. The method of claim 10, wherein the battery assembly is installed within a section of an aircraft, and wherein the method further comprises: further comprising:
regulating air pressure within the section of the aircraft.

14. The method of claim 10, wherein a first number of battery cells in the first plurality of battery cells and a second number of battery cells in the second plurality of battery cells are equal, or differ by at most two.

15. The method of claim 10, wherein the first plurality of battery cells and the second plurality of battery cells are within an enclosure within the aircraft, and wherein monitoring the one or more sense signals comprises:
sensing, by a pressure sensor of the one or more sensors, the air pressure within the enclosure; and
monitoring a sense signal output by the pressure sensor.

16. The method of claim 10, wherein the first plurality of battery cells and the second plurality of battery cells are within an enclosure within the aircraft, and wherein monitoring the one or more sense signals comprises:
sensing, by a sensor of the one or more sensors, an altitude of the enclosure, based on the air pressure within the enclosure; and
monitoring a sense signal output by the sensor.

17. A system comprising:
an aircraft;
a plurality of battery cells comprising first one or more battery cells and second one or more battery cells, the plurality of battery cells within the aircraft, wherein the aircraft is fully or at least partially powered by the plurality of battery cells;
a sensor configured to output a sense signal that is indicative of air pressure proximal to plurality of battery cells; and
a controller configured to, in response to the sense signal indicative of the air pressure being less than a threshold value, disconnect the first one or more battery cells from the second one or more battery cells.

18. The system of claim 17, further comprising:
a switch between the first one or more battery cells and the second one or more battery cells;
wherein to disconnect the first one or more battery cells from the second one or more battery cells, the controller is configured to issue a control signal that causes the switch to transition to an open state.

19. The system of claim 17, further comprising:
a first switch and a second switch; and
a first load terminal and second load terminal, wherein the plurality of battery cells is coupled to the first and second load terminals through the first switch and the second switch, respectively,
wherein the controller is further configured to, in response to the sense signal indicative of the air pressure being less than the threshold value, issue one or more control signals that cause the first and second switch to transition to an open state.

20. The system of claim 17, further comprising:
an enclosure, wherein the plurality of battery cells and the sensor are within the enclosure, and the enclosure is within the aircraft, wherein the sense signal is indicative of the air pressure within the enclosure.
